(19) United States
(12) Patent Application Publication
(10) Pub. No.: US 2026/0181027 A1
(43) Pub. Date: Jun. 25, 2026

(54) DATA COLLECTION TRIGGERING AND MANAGEMENT

(71) Applicant: InterDigital Patent Holdings, Inc., Wilmington, DE (US)

(72) Inventors: Michel Roy, Candiac (CA); Ulises Olvera-Hernandez, Saint-Lazare (CA); Taimoor Abbas, Sainte-Julie (CA); Michael Starsinic, Newtown, PA (US); Samir Ferdi, Kirkland (CA)

(73) Assignee: InterDigital Patent Holdings, Inc., Wilmington, DE (US)

(21) Appl. No.: 18/990,368

(22) Filed: Dec. 20, 2024

(51) Int. Cl. H04L 65/1069; H04W 24/04

(52) U.S. Cl. CPC H04L 65/1069; G06N 3/098; H04W 24/04; H04W 24/10

(57) ABSTRACT

Based on the performance of an artificial intelligence/machine learning (AIML) model, a wireless transmit/receive unit (WTRU) may be instructed to collect and report data. The data may be collected and reported based on a DC profile, a DC endpoint, and a DC authorization policy. A DC session may be established and a DC session identifier may be associated with the DC session. The WTRU may be one of a plurality of members authorized to collect data. The plurality of members may be associated with the DC session identifier. The WTRU may send collected data to a network. The WTRU may include the DC session identifier when sending the collected data. Collected data may be used to develop a training dataset for an artificial intelligence/machine learning (AIML) model.

### BACKGROUND

The Non-Access Stratum (NAS) protocol plays a role in mobile networks. The Non-Access Stratum (NAS) protocol refers to a layer of communication protocols used between the User Equipment (UE), also referred to as a wireless transmit/receive unit (WTRU), and the Access and Mobility Management Function (AMF) located in the Core Network (CN). The NAS protocol operates above the Access Stratum (AS) and plays a key role in managing signaling for mobility and session management. Different mobile network functions are based on the NAS protocol. For example, a first function based on the NAS protocol is Mobility Management (MM). The NAS protocol facilitates manage location updates as the WTRU moves between tracking areas (TAs) and includes procedures like initial registration, deregistration, and connection management.

A second function based on the NAS protocol is Session Management (SM). The NAS protocol facilitates the establishment, modification, and release of Protocol Data Unit (PDU) sessions for data transmission and support Quality of Service (QoS) management for applications.

A third function based on the NAS protocol is security management. The NAS protocol facilitates mutual authentication between the WTRU and the Core Network (CN) network and facilitate encryption and integrity protection for NAS messages.

A fourth function based on the NAS protocol is paging coordination. The NAS protocol facilitates re-establishing communications with the WTRU when in idle mode.

A fifth function based on the NAS protocol is support for 5G system features. The NAS protocol facilitates slicing support, allowing the WTRU to connect to specific network slices based on service requirements, and enables managing data collection and mobility across heterogeneous networks.

The NAS protocol ensures efficient and secure communication between the WTRU and the 5G core (5GC) network by supporting features and functions expected in 5G networks. Examples of supported functions include secure and encrypted communications, mobility support, session management, scalability (e.g., large number of devices), QoS differentiation, etc.

However, the NAS protocol does not offer support for data collection and data collection session triggering or management in 5G systems.

### SUMMARY

Data Collection (DC) may be performed by a WTRU to build a relevant training dataset for model training or collected data may be utilized to update a relevant training dataset for model retraining due to the changing conditions and parameters. Mechanisms are described herein regarding how ML model performance degradation may be detected and reported to the network. Mechanisms address how the data collection session may be triggered (e.g., established) and terminated by the WTRU and/or by the RAN nodes for ML model (re)training based on the event reporting.

A Data Collection Function (DCF), Data Collection Server Function (DCSF), and/or Data Collection Server (DCS) may be responsible for the management of Data Collection Configuration Profile (DCCP), and/or DC Policy (DCP). A DCF may be in the 3GPP 5G and/or next generation core network as an independent core network function or it may collocate with another core network function. A DCF may be in the application layer domain as a data collection server function located with the application function. The DCP may be used to configure the WTRU and the network nodes with regards to collected data content and its handling before its transfer to an AI/ML training entity, such as an over-the-top (OTT) server, a (e.g., OTT server, a network data analytics function (NWDAF), or the like.

As described herein, to facilitate data collection triggering and management, a WTRU may detect a condition that requires a DC session, as further explained herein with reference to FIG. 3. The WTRU send a message to report the detected condition or alternatively request a DC session to be established, as further explained herein reference to FIG. 3. The WTRU may receive a message indicating that a DC session has been authorized, as further explained herein with reference to FIG. 5. The WTRU may be configured to perform data collection and communicate the collected data according to a DC profile, DC endpoint, and a DC policy, as further explained herein with reference to FIG. 5. The WTRU may send a stream of data containing the collected data and according to a DC endpoint and DC policy, as further explained herein with reference to FIG. 5. And, the WTRU may send or receive a message indicating a DC session termination, as further explained herein with reference to FIG. 6.

As described herein, to facilitate data collection triggering and management, a data collection function (DCF) may receive a message indicating that a DC session needs to be established, as further explained herein with reference to FIG. 5. The DCF may configure a DC session according to a DC profile, DC endpoint, and a DC policy, as further explained herein with reference to FIG. 5. The DCF may send a message to establish a DC session, as further explained herein with reference to FIG. 5. A DCF may monitor DC sessions according to a DC policy, as further explained herein with reference to FIG. 5. And, the DCF receive a message indicating a DC session termination, as further explained herein with reference to FIG. 6.

As described herein, to facilitate data collection triggering and management, a network function (NF) may receive a message indicating that a DC session needs to be established, as further explained herein with reference to FIG. 2. The NF may determine if the DC session is needed and select the members for participating in the DC session, as further explained herein with reference to FIG. 2. The NF may send a message indicating that a DC session needs to be established for the selected members, as further explained herein with reference to FIG. 5. The NF may receive a message indicating that the DC session is established, as further explained herein with reference to FIG. 5. The NF may receive multiple messages associated with a DC session identifier and containing collected data, as further explained herein with reference to FIG. 5. The NF may use the collected data for performing an action requiring the collected data, as further explained herein with reference to FIG. 5. And, the NF may send or receive a message indicating a DC session termination, as further explained herein with reference to FIG. 6.

An example WTRU may comprise a transceiver and a processor. The processor may be configured detect a data collection (DC) condition, wherein the DC condition may be based upon performance of an artificial intelligence/machine learning (AIML) model. The processor may be configured to, based on the detected DC condition, send, via the transceiver, a first message, wherein the first message may comprise at least one of an indication that the DC condition has been detected or a request to establish a DC session. The processor may be configured to receive, via the transceiver, a second message, wherein the second message may comprise an indication that a DC session has been established and an indication of a DC session identifier associated with the session. The processor may be configured to receive, via the transceiver, configuration information, wherein the configuration information may comprise an indication for the WTRU to collect and report data based on a DC profile, a DC endpoint, and a DC authorization policy. The processor may be configured to collect data based on the DC profile and the DC authorization policy. The processor may be configured to send, via the transceiver, an indication of the DC session identifier and at least a portion of the collected data to the DC endpoint. The processor may be configured to receive, via the transceiver, a third message, the third message comprising an indication of a DC session termination.

The DC session identifier may be associated with a plurality of members for collecting and reporting the data. The DC profile may comprise an indication of data to be collected. The DC profile may comprise an indication of data reporting connectivity. The DC profile may comprise an indication of members associated with the DC session identifier. The DC authorization policy may comprise an indication of members associated with the DC session that are authorized to collect data. The DC condition may be based upon performance degradation of the AIML model. The processor may be further configured to send an indication of performance degradation of the AIML model. The DC authorization policy may comprise an indication that the WTRU is authorized to collect data. The DC authorization policy may comprise an indication of members associated with the DC session that are authorized to collect data.

An example method performed by a WTRU, may comprise sending a measurement prediction capability. The method may comprise detecting a data collection (DC) condition, wherein the DC condition may be based upon performance of an artificial intelligence/machine learning (AIML) model. The method may comprise, based on the detected DC condition, sending a first message, wherein the first message may comprise at least one of an indication that the DC condition has been detected or a request to establish a DC session. The method may comprise receiving a second message, wherein the second message may comprise an indication that a DC session has been established and an indication of a DC session identifier associated with the session. The method may comprise receiving configuration information, wherein the configuration information may comprise an indication for the WTRU to collect and report data based on a DC profile, a DC endpoint, and a DC authorization policy. The method may comprise collecting data based on the DC profile and the DC authorization policy. The method may comprise sending an indication of the DC session identifier and at least a portion of the collected data to the DC endpoint. The method may comprise receiving a third message, the third message comprising an indication of a DC session termination.

The DC session identifier may be associated with a plurality of members for collecting and reporting the data. The DC profile may comprise an indication of data to be collected. The DC profile may comprise an indication of data reporting connectivity. The DC profile may comprise an indication of members associated with the DC session identifier. The DC authorization policy may comprise an indication of members associated with the DC session that are authorized to collect data. The DC condition may be based upon performance degradation of the AIML model. The method may comprise sending an indication of performance degradation of the AIML model. The DC authorization policy may comprise an indication that the WTRU is authorized to collect data. The DC authorization policy may comprise an indication of members associated with the DC session that are authorized to collect data.

### BRIEF DESCRIPTION OF THE DRAWINGS

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 is an example depiction of data collection triggering and management overview.

FIG. 3 is an example depiction of a machine learning (ML) model performance degradation detection and reporting procedure.

FIG. 4 is an example depiction of a data collection triggering procedure.

FIG. 5 is an example depiction of a data collection session establishment procedure.

FIG. 6 is an example depiction of a data collection session termination procedure.

### EXAMPLE NETWORKS FOR IMPLEMENTATION OF THE INVENTION

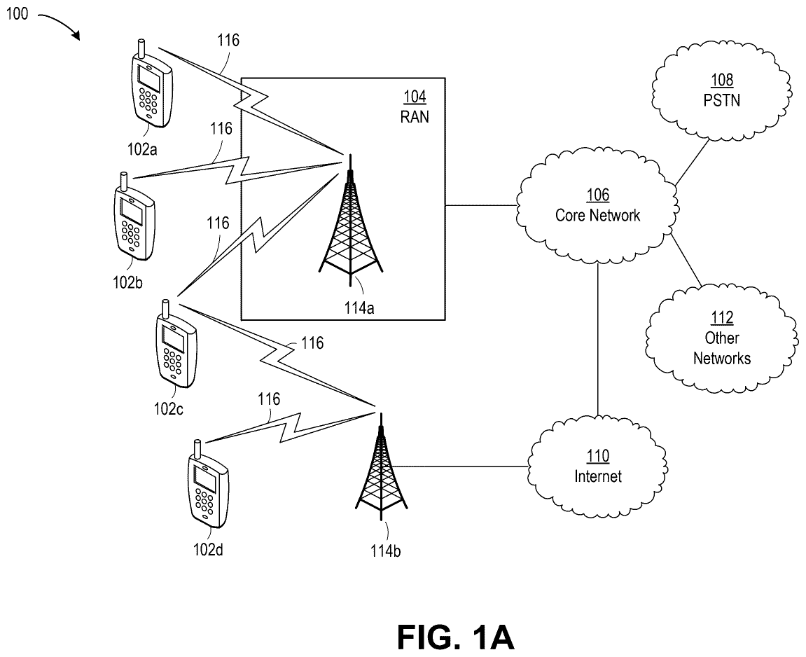

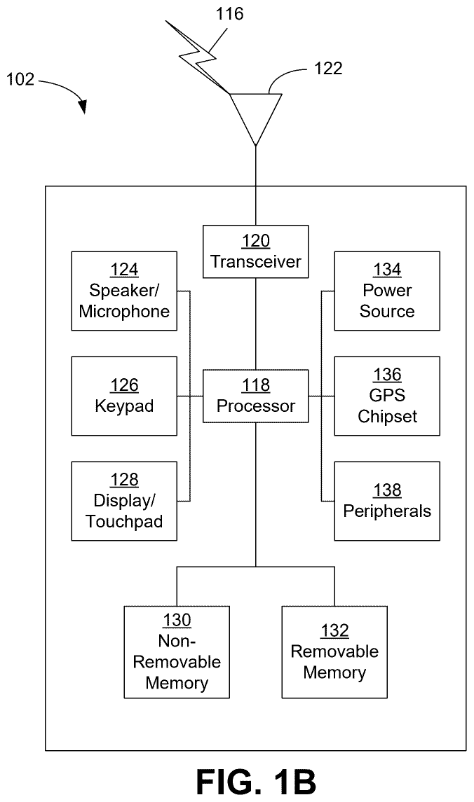

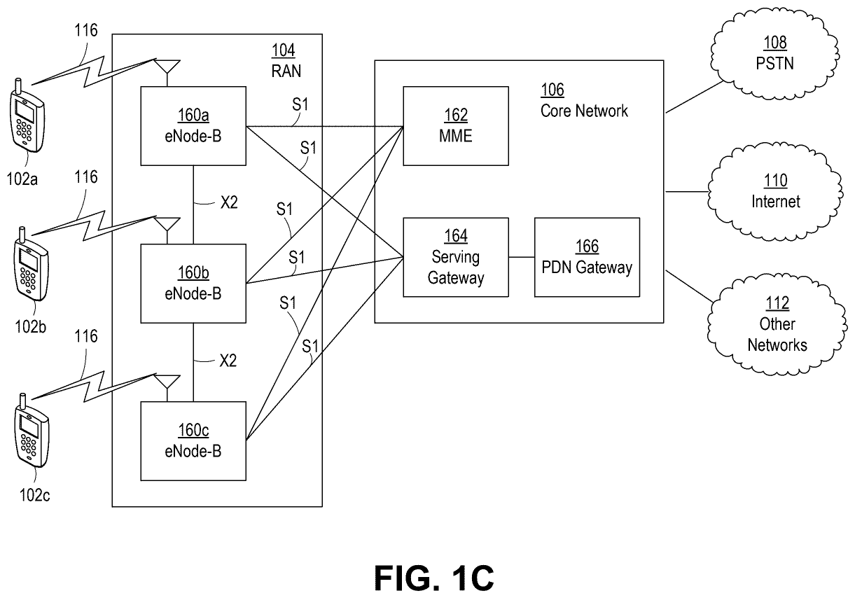

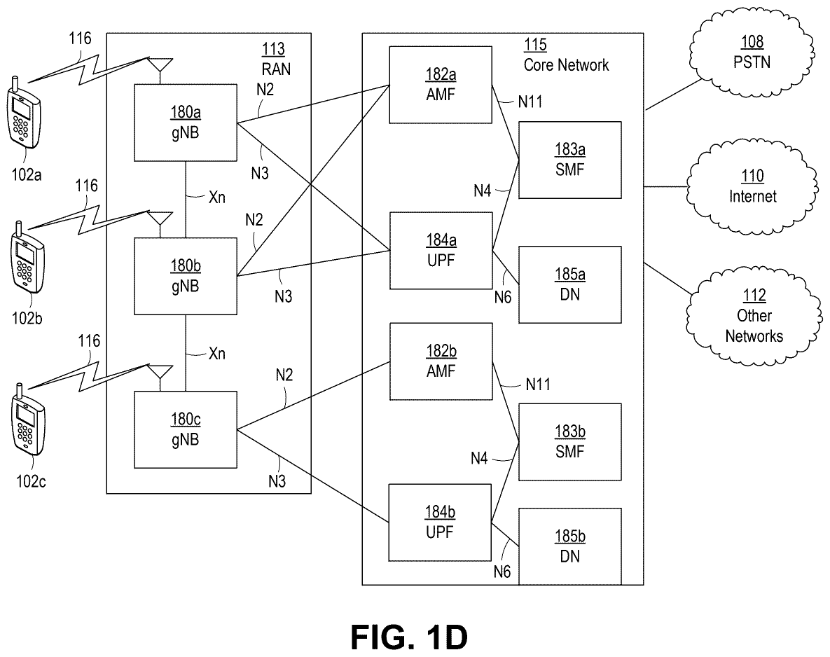

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP (third generation partnership project) access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Mobile networks may benefit from using machine learning (ML) models to predict network behaviors. One area that may benefit from the usage of ML models is the Radio Access Network (RAN) for tasks such as beam pattern prediction, location prediction, and Channel State Information (CSI) prediction. RAN ML scenarios may benefit from a coordinated ML model deployment where a first ML model is deployed at the WTRU for performing WTRU side inferences and a second ML model is deployed at the RAN node (e.g., gNodeB) for performing network side inferences. However, ML model (re)training may be appropriate based on changing network conditions and detection of model performance degradation. Furthermore, it can be appreciated that ML model training and/or retraining (referred to herein as (re)training) may be performed by a functional entity located in the network (e.g., a network function or application function) and that ML model (re)training may be dependent on data collection at the WTRU.

One aspect applicable to support ML model (re)training is the need to trigger and manage data collection with one or more functional entity in the mobile network. A first challenge is related to triggering a data collection (DC) session establishment for one or more functional entities, such as WTRU(s) and gNodeB(s), for supporting use cases such as the (re)training process for a WTRU and/or a RAN node. The challenge is related to the distributed nature of these nodes in a mobile network which may utilize input data collected at several WTRUs and or gNodeBs to be aggregated at a single endpoint.

Another aspect is related to managing the DC session after is has been established. For example, coordinating the establishment and termination of a DC session that involves several WTRUs and gNodeBs with the (re)training process of a ML models may be complex.

A third challenge is related to providing DC policies that enable the authorization of DC sessions across multiple functional entities.

Data Collection (DC) plays an important role in in ML and artificial intelligence (AI). DC is foundational to the success of AI and ML systems as it can impact both training and inference stages. The role of data collection for training ML models and using ML models for inference is described hereafter. For example, ML model training may involve creating an accurate model based on a provided dataset. An accurate model is a model that has been trained to infer predictions and is performing to a certain level of accuracy (e.g., predictions are accurate). The role of data collection in ML model training may be associated with different stages of a training process. A ML model training stage may build a relevant training dataset based on collected data (e.g., data quality, quantity, relevance). For example, a ML model training stage may utilize extracting features, or in other words processing collected raw data into features that can be used by the trained ML model. A ML model training stage may require collected data labeling, or in other words annotating collected data with labels that can be used by the ML model to learn patterns. A ML model training stage may require collected data bias reduction, or in other words varied collected data to reduce prediction bias.

The ML model usage for inference may involve making predictions or decisions based on new data (e.g., data different than the training data). The role of data collection in ML model inference may be associated with various use cases. For example, a ML model inference use case may utilize data collection for providing real-time input data; the quality and accuracy of real-time collected data may impact the model's prediction accuracy.

Further, the role of data collection in ML model inference may be related to collecting inference data use cases. For example, a ML model inference results data collection may be necessary for continuous learning use cases where inference results are collected to be fed back into a ML model for retraining purposes. A ML model inference results data collection may apply to contextual understanding use cases where a ML model may rely on collected contextual data (e.g., user behavior, environment) to provide accurate predictions.

Data collection is the foundation for both the training and inference phases of AI and ML systems. High-quality and representative data ensures models are accurate, fair, and reliable, while real-time data collection during inference enables adaptive and context-aware applications.

Described herein is a DC framework for managing DC sessions with one or more WTRUs and network nodes, such as gNodeBs, for example. A standardized DC framework for mobile networks may enable new use cases. For example, the distributed training of ML models (e.g., federated learning use cases) may rely on data collection from one or more WTRU(s) or gNodeB(s) to provide a dynamic training dataset and support ML model (re)training use cases. Use cases, such as spatial mapping, utilizing the collection of sensing data at the WTRU may also benefit from a standardized data collection framework.

As described in more detail herein, service-based messaging refers to application layer messaging that is related to the invocation of services. The services that are invoked may be provided by a network function or an application function. The application function (AF) or network function (NF) described herein may be a server offering a service via an application program interface (API). The AF or NF may be any server authorized to communicate with the mobile network functional elements, including servers that may be specified in the 3GPP network architecture. For example, the AF or NF may be a NWDAF, an AIML Enablement (AIMLE) server, a Spatial Mapping server, a Spatial Computing server, an application data analytics enablement service (ADAES) server, a server specified in the 3GPP operations, administration and maintenance (OAM) architecture, or any server specified in the 3GPP network architecture.

The data collection function (DCF)may be a function for DC session management that can be implemented as a service. The DCF may be implemented as a standalone server (e.g., NF or AF). DCF functionality may be implemented as part of an existing server specified in the 3GPP network architecture. For example, DCF functionality may be implemented in a NWDAF server, in an AIML Enablement server, in a Spatial Mapping server, a Spatial Computing server, in an ADAES server, in a server specified in the 3GPP OAM architecture, or in any server specified in the 3GPP network architecture.

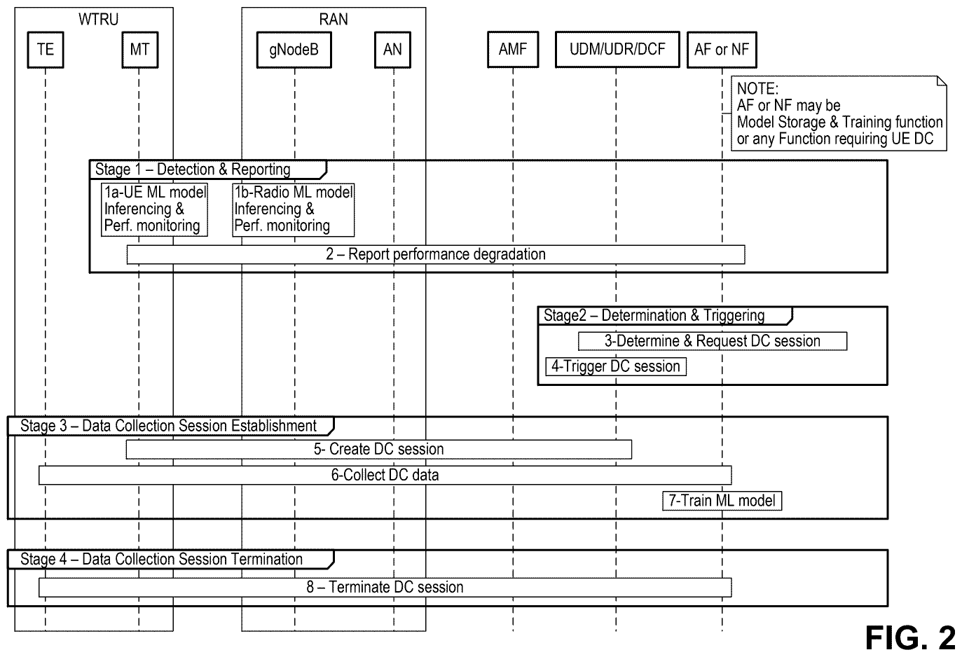

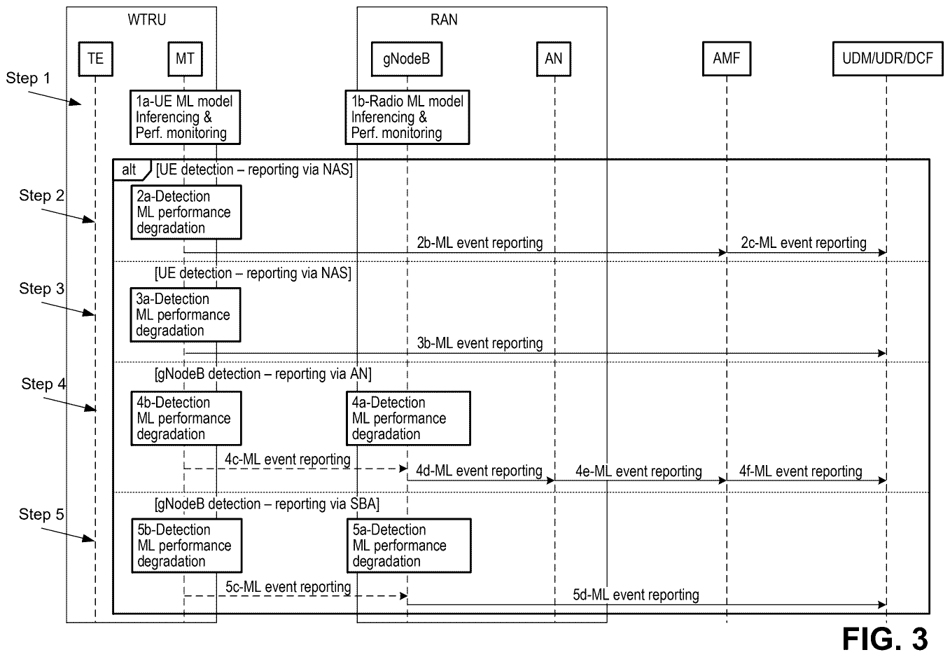

FIG. 2 is an example depiction of data collection triggering and management overview. FIG. 2 depicts an example use case based on ML model (re)training introducing 4 stages associated with managing a DC session. The high-level overview of the data collection session triggering and management procedure for WTRU data collection can be described in stages, as depicted in FIG. 2. A first stage may be for detecting a condition for triggering a determination that a DC session is needed. For example, this condition may be detecting and reporting a ML model performance degradation to trigger a ML model (re)training. This first stage is introduced in FIG. 2 and further described in FIG. 3.

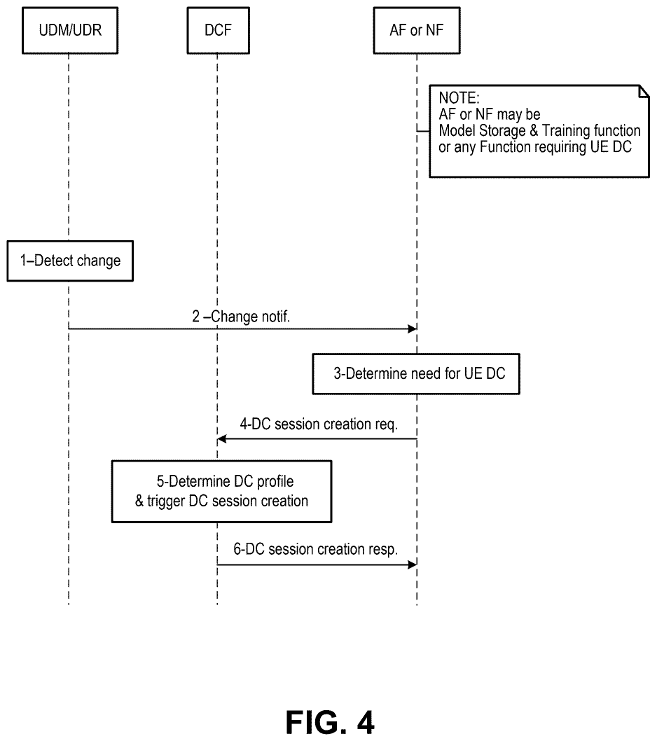

A second stage may be for triggering an AF or NF for determining if a DC session is required. For example, an AF or NF may determine if a DC session is needed based on a determination that a ML model (re)training is needed and may trigger a DC session establishment based on the ML model training needs. This second stage is introduced in FIG. 2 and further described in FIG. 4.

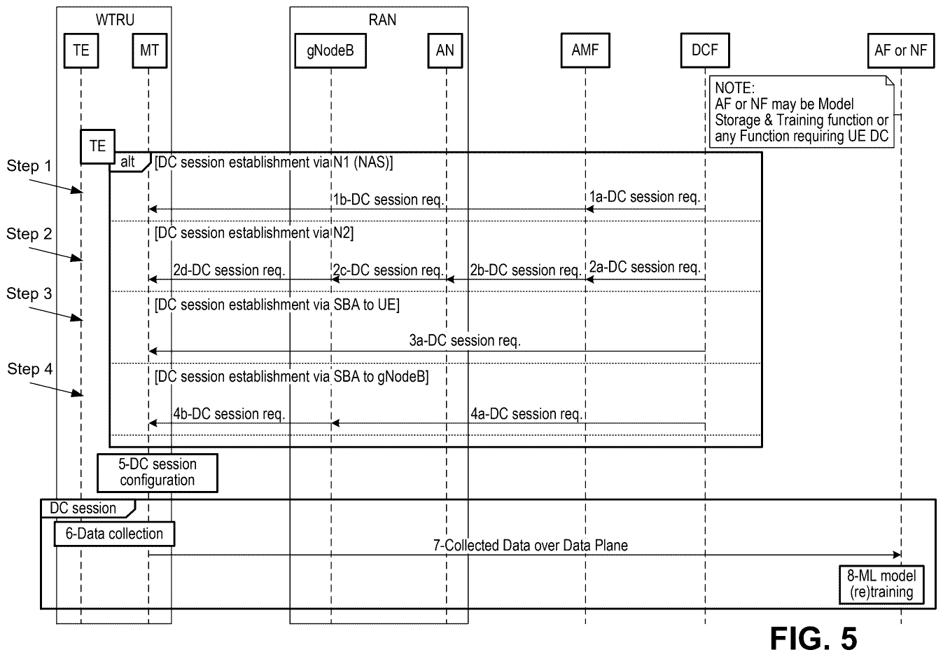

A third stage may be for initiating a Data Collection session with one or more functional entities. For example, a DC session may be established for one or more WTRU and/or gNodeBs for performing ML model (re)training and the DC data is aggregated at the AF or NF for training a ML model. This third stage is introduced in FIG. 2 and further described in FIG. 5.

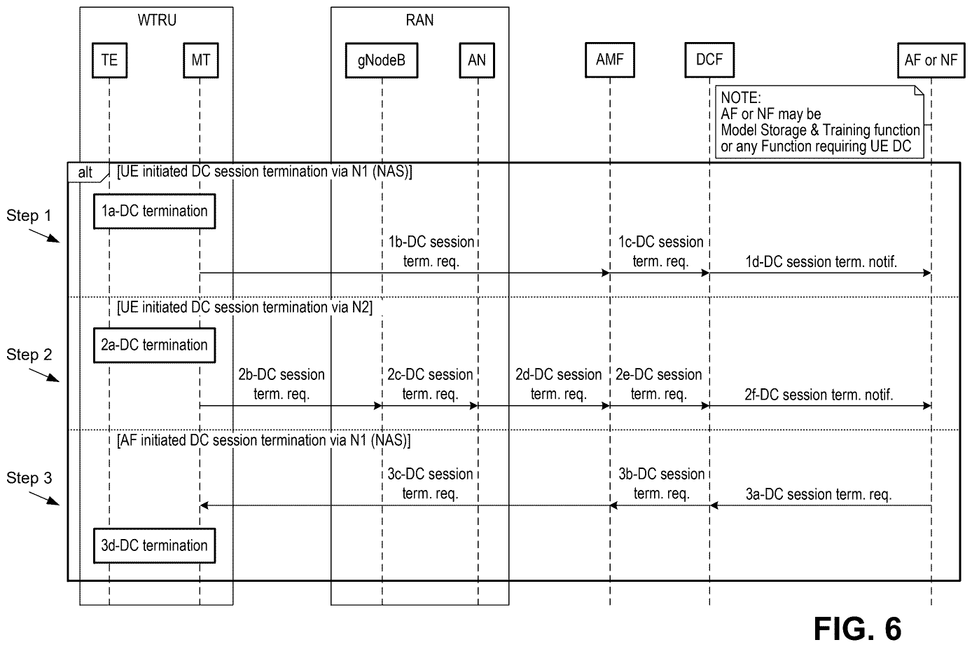

A fourth stage may be for terminating a Data Collection session with one or more functional entities. For example, a DC session may be terminated once an AF or NF determines that the performance of a ML model in-training is sufficient. This fourth stage is introduced in FIG. 2 and further described in FIG. 6.

As depicted in FIG. 2, Stage 1, Detection & Reporting, may comprise step 1 and step 2. A high-level description of ML model performance degradation detection and reporting is described in step 1 and step 2 hereafter and is further described in FIG. 3. In step 1, the Mobile Termination (MT) component of a WTRU and the gNodeB may have been respectively provisioned with a WTRU model (1a) and a gNodeB model (1b) for performing predictions. The ML models may be used to perform beam forming predictions, WTRU location predictions or CSI prediction. Additionally, the MT and/or gNodeB may have been provisioned with performance monitoring information that allows for determination of the performance of their respective ML models and detect ML model performance degradation.

In step 2, the MT and/or gNodeB may detect a ML model performance degradation of the ML model using the provisioned performance monitoring information. The MT and/or gNodeB may report the detected ML model performance degradation to the network.

The MT may receive a notification from the network that ML model performance degradation has been detected. The notification may be received from the core network in a NAS message. The notification may be received from the base station in a radio resource control (RRC) message.

In a first communication procedure, performance degradation may be reported directly to an AF or NF by sending a message to the AF or NF (e.g., if service-based communications is supported) or may be reported indirectly (e.g., via the AMF) to the AF or NF by sending a NAS message. The AF or NF may associate the performance degradation information with a ML model profile. The AF or NF may store the performance degradation information locally or in a unified data management/unified data repository (UDM/UDR).

In a second (e.g., alternative) communication procedure, performance degradation may be reported directly to the UDM/UDR by sending a message to the UDM/UDR (e.g., if service-based communications is supported) or may be reported indirectly to the UDM/UDR via the AMF by sending a NAS message. The UDM/UDR may associate the performance degradation information with a ML model profile. The UDM/UDR may notify an AF or NF about the performance degradation. The ML model performance degradation may be detected and reported by the MT, by the gNodeB or both.

The ML model performance degradation may be reported by the MT directly or indirectly or may be reported via the gNodeB if protocols, such as, for example, radio resource control (RRC), uplink control information (UCI), medium access control-control element (MAC-CE), or the like, used between the MT and gNodeB allow reporting ML model degradation.

The ML model performance degradation may be reported by the gNodeB directly or indirectly (e.g., via the AMF). The gNodeB may report the ML model performance degradation via the AMF if the AN and the N2 interface allow reporting ML model degradation.

As depicted in FIG. 2, Stage 2, Determination & Triggering, comprises step 3 and step 4. A high-level description of determining a need for data collection and triggering a data collection session is described in step 3 and step 4 hereafter and is further described in FIG. 4. In step 3, the AF or NF may determine that a ML model (re)training is required. The determination may be based on a performance degradation report received from a MT and/or a gNodeB. The AF or NF may identify the ML model to be (re)trained via a model identifier received in the report and may further determine a Data Collection profile (DCP or DC profile) associated with the ML model. The DC profile may contain any information related to data collection at the WTRU. For example, the DC profile may indicate which data needs to be collected, data collection patterns, data reporting connectivity/security/encryption, etc. The AF or NF may request a DC session establishment with the DCF.

The ML model training may be performed by a functional entity such as a Network Function (NF), such as the NWDAF, or may be performed by a functional entity such as an Application Function (AF) such as the AIMLE Server or an Over-The-Top server (OTT) server.

In step 4, the DCF may trigger a DC session establishment. The DCF may determine, create, or be provided with a DC profile and may further be provided with a list of functional entities (e.g., members) to include in the DC session. The DCF may trigger the establishment of a DC session with one or more members. Communication between the DCF and the NF or AF may be direct or indirect via the NEF.

As depicted in FIG. 2, Stage 3, Data Collection Session Establishment, comprises step 5, step 6, and step 7. A high-level description of initiating a Data Collection session for performing ML model (re)training is described in step 5, step 6 and step 7 hereafter and is further described in FIG. 5. In step 5, the DCF may initiate a DC session with one or more WTRUs and/or gNodeBs. The data collection session may be initiated directly by sending a service-based message to the WTRU and/or gNodeBs if such communication is supported or may be initiated indirectly via the AMF (e.g., NAS message or via the AN—Access Network interface). Upon being informed of a DC session initiation, the WTRU may use a DC profile to determine which data needs to be collected, the parameters of data collection (e.g., frequency, time, etc.), the communication parameters for the data collection, including the connectivity and endpoint where to send the collected data and may establish a PDU session to the provided endpoint.

A DC session may alternatively be initiated at the WTRU via the gNodeB. The DCF may communicate with the gNodeB directly if service-based messages are supported or indirectly via the AMF and AN (e.g., N2 interface). The gNodeB may indicate the DC session initiation to the MT if the protocols (e.g., RRC, DCI, MAC-CE) between the MT and gNodeB support indicating a DC session initiation.

One or more WTRUs or gNodeBs for which a data collection is initiated may be determined by the AF, NF, or DCF. The AF or NF may provide a list of member WTRUs or gNodeBs for data collection (e.g., in step 3) when ML model training is made at the AF or NF and the list of member WTRUs or gNodeBs may be determined based on the WTRU or gNodeB capabilities to support the ML model and/or perform data collection. The DCF may have the capability of selecting member WTRUs and/or gNodeBs for data collection (e.g., in step 4) based on the WTRU or gNodeB capabilities to support the ML model and perform data collection. In step 6, the WTRU and/or gNodeB may perform data collection and send the collected data according to the DC profile.

In step 7, the ML model training entity (e.g., NWDAF, AIMLE server, AF, NF) may receive the data collected by one or more WTRUs and/or gNodeB and may use this information for training the ML model.

As depicted in FIG. 2, Stage 4, Data Collection Session Termination, comprises step 8. A high-level description of terminating a Data Collection session is described in step 8 hereafter and is further described in FIG. 6. In step 8, the DC session may be terminated. The DC session termination may be initiated by the WTRU, the gNodeB, or the AF. The DC session termination may be initiated due to certain conditions, e.g., network load, data collection timer has expired, or due to WTRU power constraints etc. The request may include a DC profile identifier associated with the DC session and/or a DC session identifier, and additionally may include a reason for terminating the DC session using a termination cause code.

FIG. 3 is an example depiction of a machine learning (ML) model performance degradation detection and reporting procedure. FIG. 3 depicts an example use case based on ML model (re)training is introduces four stages associated with managing a DC session. FIG. 3 describes alternative examples of a ML model performance degradation detection and reporting. FIG. 3 is a detailed view of Stage 1 of FIG. 2. The example procedure depicted in FIG. 3 shows that a DC session establishment may be triggered by a WTRU or a gNodeB detecting and reporting a ML model performance degradation to the network. A WTRU or a gNodeB may directly trigger DC session establishment and the “ML event reporting” message described in steps 2, steps 3, steps 4, and steps 5 of FIG. 3 may be interchangeable with “DC session establishment” messages that may be sent to the network for triggering the establishment of a DC session.

In step 1, the Mobile Termination (MT) component of a WTRU and the gNodeB may have been respectively provisioned with a WTRU model (1a) and a gNodeB model (1b) for performing predictions and termination preferred configuration information. The ML models may be used in procedures that involve performing beam forming predictions, WTRU location predictions or CSI prediction.

Additionally, the MT and/or gNodeB may have been provisioned with performance monitoring information that allows determination of the performance of their respective ML models and detect ML model performance degradation. A threshold value on communication error rate, a threshold value on a position deviation or a threshold value on CSI may be considered to determine the performance of an associated ML model inferences. The performance monitoring information also may include the quality of service (QoS)/quality of experience (QoE) thresholds, e.g. min. and max degradation levels, time-window for which the performance drops below a threshold, per functionality and/or per ML model, which could be provisioned in the MT and gNodeB as part of the data collection configuration profile/policy or as a dedicated performance monitoring key performance indicators (KPIs). The MT and/or gNodeB may also have been provisioned with the NF ID that can be used for the event reporting.

The MT and gNodeB may be using their respective ML models to perform predictions by providing locally available measurements as input parameters to the ML models and collecting the prediction output. The collected prediction output may then be used by the MT or gNodeB to perform actions related to the collected prediction output, such as, for example, performing actions related to beamforming, taking actions based on the predicted UE location or taking CSI related actions.

A ML model may be present on the WTRU only, may be present on the gNodeB only, or may be present on both the WTRU and gNodeB.

The ML models may be identified by a respective ML model identifier and the ML model identifier may further identify the category of the ML model (e.g., for WTRU beam forming, for WTRU location prediction, for WTRU channel state information—CSI prediction, etc.). Thus, a ML model identifier may be well-known in the system and identify both the ML model and category of ML model.

Alternative methods for reporting ML model performance degradation are further described. In step 2, a first alternative for reporting the degradation of a ML model performance is described. In the first alternative, the WTRU MT may detect a ML model performance degradation, e.g., based on the thresholds specified in step 1, and report it to the network via a NAS message. The MT may detect a ML model performance degradation (2a) using the provisioned performance monitoring information described in step 1 of FIG. 3. The MT may perform ML model performance monitoring and detect a degradation of the prediction performance. The detection of the performance degradation may be based on threshold values, on measurements at the WTRU, or on an indication from the network that the actions taken by the WTRU based on the prediction (e.g., beam forming, location, CSI) are not appropriate. For example, an indication from the gNodeB to the MT may be communicated via the RRC layer, via Downlink Control Information (DCI) or via a Medium Access Control Element (MAC-CE).

The MT may determine to report the detected performance degradation to the network. The MT may send a NAS message, e.g., UL NAS transport message, mobility registration update, attach request etc. (2b) to the network to indicate the detected ML event (e.g., performance degradation). The NAS message may include the ML model identifier, the WTRU identifier, and information about the detected event. Information about the detected event may indicate that a ML model performance degradation has been detected and may include the determined deviation from threshold values. Upon receiving the NAS message from the WTRU, the AMF may send (2c) the reported ML event and information received in the NAS message to the UDM/UDR or DCF. The AMF may have determined the selection of UDM/UDR or DCF associated with the UE at UE registration time and may have updated the selection of UDM/UDR or DCF on UE mobility events. The message sent to the UDM/UDR or DCF may be a service-based message. The actions taken by the UDM/UDR or DCF upon receiving the service-based message from the AMF are further described in FIG. 4.

The message sent in step 2b and step 2c of FIG. 3 may be a DC session establishment request, and the message may additionally include an AF or NF identifier which identifies the AF or NF for which the DC session is requested.

In step 3, a second alternative for reporting the degradation of a ML model performance is described. In the second alternative, the WTRU MT may detect a ML model performance degradation and report it to the network via a service-based message. The MT may detect a ML model performance degradation (3a) as described in step 2a of FIG. 3.

The MT may determine to report the detected performance degradation to the network. The MT may send a service-based message (3b) to the UDM/UDR or DCF to indicate the detected ML event (e.g., performance degradation). The service-based message may include the ML model identifier, the WTRU identifier, and information about the detected event. For example, information about the detected event may indicate that a ML model performance degradation has been detected and may include the determined deviation from the threshold values and the used threshold values.

The MT may have determined the selection of UDM/UDR or DCF at WTRU registration time and may have updated the selection of UDM/UDR or DCF on WTRU mobility events. The registration accept message or registration update message may include the UDM/UDR or DCF selection information, including the information for sending service-based messages the UDM/UDR or DCF. Alternatively, the MT may perform a procedure with a network repository function (NRF) (not shown on FIG. 3) to obtain the UDM/UDR or DCF selection information. The actions taken by the UDM/UDR or DCF upon receiving the service-based message from the MT are further described in FIG. 4.

The message sent in step 3b of FIG. 3 may be a DC session establishment request, and the message may additionally include an AF or NF identifier which identifies the AF or NF for which the DC session is requested.

In step 4, a third alternative for reporting the degradation of a ML model performance is described. In the third alternative, the gNodeB may report a ML model performance degradation to the network via the AN interface. The gNodeB may detect a ML model performance degradation (4a) as described in step 2a of FIG. 3. The gNodeB may detect a ML model performance degradation (4a) using the provisioned performance monitoring information described in step 1 of FIG. 3. The gNodeB may perform ML model performance monitoring and detect a degradation of the prediction performance. The detection of the performance degradation may be based on threshold values, on measurements at the gNodeB or on an indication from the WTRU that the actions taken by the WTRU based on the prediction (e.g., beam forming, location, CSI) are not appropriate. An indication from the WTRU to the gNodeB may be communicated via the RRC layer, via Uplink Control Information (UCI) or via Medium Access Control Elements (MAC-CE).

Alternatively, the MT may detect a ML model performance degradation (4b) as described in step 2a of FIG. 3 and the MT may inform the gNodeB (4c) about the ML model performance degradation.

The MT may send an indication (4c) of the ML model performance degradation detection to the gNodeB. An indication from the MT to the gNodeB may be communicated via the RRC layer, via Uplink Control Information (UCI) or via a Medium Access Control Element (MAC-CE). The communicated information may include the ML model identifier, the WTRU identifier, and information about the detected event. For example, information about the detected event may indicate that a ML model performance degradation has been detected and may include the determined deviation from the threshold values and the used threshold values.

The gNodeB may determine to report the detected performance degradation to the network. The gNodeB may send a message (4d) to the AN to indicate the detected ML event (e.g., performance degradation). The message may include the ML model identifier, the WTRU identifier, and information about the detected event. Information about the detected event may indicate that a ML model performance degradation has been detected and may include the determined deviation from the threshold values and the used threshold values.

The AN may send a message (4e) to the AMF to indicate the detected ML event (e.g., performance degradation). The message may include the ML model identifier, the WTRU identifier, and information about the detected event. Information about the detected event may indicate that a ML model performance degradation has been detected and may include the determined deviation from the threshold values and the used threshold values.

The AMF may send a message (4f) to the UDM/UDR or DCF to indicate the detected ML event as described in step 2c of FIG. 3. The actions taken by the UDM/UDR or DCF upon receiving the service-based message from the MT are further described in FIG. 4.

The message sent in step 4c, step 4d, step 4e, and step 4f of FIG. 3 may be a DC session establishment request, and that the message may additionally include an AF or NF identifier which identifies the AF or NF for which the DC session is requested.

In step 5, a fourth alternative for reporting the degradation of a ML model performance is described. In the fourth alternative, the gNodeB reports a ML model performance degradation to the network via a service-based message. The gNodeB may detect a ML model performance degradation (5a) as described in step 2a of FIG. 3 and further described in step 4a of FIG. 3.

Alternatively, the MT may detect a ML model performance degradation (5b) as described in step 2a of FIG. 3 and the MT may inform the gNodeB (5c) about the ML model performance degradation as described in step 4c of FIG. 3.

The gNodeB may determine to report the detected performance degradation to the network. The gNodeB may send a service-based message (5d) to the UDM/UDR or DCF to indicate the detected ML event (e.g., performance degradation). The service-based message may include the ML model identifier, the WTRU identifier, and information about the detected event. Information about the detected event may indicate that a ML model performance degradation has been detected and may include the determined deviation from the threshold values and the used threshold values. The gNodeB may have determined the selection of UDM/UDR or DCF by performing a procedure with the NRF (not shown on FIG. 3) to obtain the UDM/UDR or DCF selection information. The actions taken by the UDM/UDR or DCF upon receiving the service-based message from the gNodeB are further described in FIG. 4.

The message sent in step 5c and step 5d of FIG. 3 may be a DC session establishment request, and that the message may additionally include an AF or NF identifier which identifies the AF or NF for which the DC session is requested.

FIG. 4 is an example depiction of a data collection triggering procedure. FIG. 4 describes an example procedure for data collection triggering. FIG. 4 is a detailed view of Stage 2 of FIG. 2. Step 1 and the message in step 2 of FIG. 4 represent an example of a message sent to an AF or NF to trigger the need to determine that a DC session is needed. As such, an AF or NF may determine the need for a DC session based on events that are not shown on FIG. 4. For example, the AF or NF may determine that a DC session is needed based on receiving a message from any other functional entity, based on a timer event expiring, based on a time of day, or based on an internal determination.

As depicted in FIG. 4, the UDM/UDR may detect that ML model performance has degraded. This procedure may alternatively be performed by an NF other than the UDM/UDR. For example, the NWDAF may detect that the ML model performance has degraded based on monitoring measurements from the RAN and OAM System. The OAM system may detect that the ML model performance has degraded based on monitoring measurements from the RAN. An AF may detect that the ML model performance has degraded based on monitoring QoE measurements. For example, the RAN may detect that the ML model performance has degraded based on monitoring WTRU measurements, performing measurement procedures, detecting a change of channel conditions, or detecting a congestion event.

In step 1, the UDM/UDR may detect that a change to a resource for which an AF has subscribed. For example, the UDM/UDR may detects that a ML model performance is degraded, the detection may be triggered by receiving a service-based message indicating a ML event as described in FIG. 3. The UDM/UDR may determine to update a resource stored at the UDM/UDR upon receiving a message. Upon receiving a service-based message, the UDM/UDR may determine to update a ML profile to indicate that the ML performance is degraded. The ML profile may include information related to the use of a ML model by a WTRU or a gNodeB. The ML profile may include the ML model identifier, the WTRU identifier, the ML model performance characteristics, the ML model thresholds for determining the ML model performance and the current performance state of the ML model.

In step 2, the UDM/UDR may notify subscribers about the resource change at the UDM/UDR. The AF or NF may have subscribed to the UDM/UDR to be notified about ML profile updates, and the UDM/UDR may determine based on the subscription information that the AF or NF needs to be notified. The UDM/UDR may send a resource change notification message to the AF or NF. The message may include a ML profile and/or ML profile identifier and may include information about the event that triggered the message. For example, the message sent to the AF or NF may include the ML profile, the ML profile identifier, the indication that the profile was updated due to a ML event indicating a ML model performance degradation, and information about the WTRU and/or gNodeB that triggered the event.

In step 3, upon receiving the resource change notification, the AF or NF may determine whether the event requires triggering a WTRU data collection session, may determine data collection requirements (e.g., data to be collected, frequency, period, etc.), may determine members that should be part of a data collection session, and/or may determine endpoint(s) where the data collected should be sent.

The AF or NF may perform a first determination that a ML model performance degradation requires a ML model (re)training and may perform a second determination that a DC session is needed to (re)train the ML model. Additionally, the AF or NF may perform a third determination that members need to be selected for the ML model training. The member selection determination may be a selection of WTRUs and/or gNodeB for providing the collected data for the ML model training, and the selection may be based on WTRUs or gNodeBs that are currently using the ML model to be trained which may be known at the AF or NF or may be based on WTRUs that have indicated a capability to perform ML model training. The data collection requirements may be related to the ML model characteristics, including the input parameters for training, reporting frequency and/or period, and may be determined based a ML model profile associated with a ML model. The endpoint where to send the collected data may be determined based on selected node(s) that will perform the ML model training and may be associated with a ML model training session identifier.

In step 4, the AF or NF may send a DC session creation request to the DCF. The determination to send the message may be based on the determinations of step 3a of FIG. 4. The request may include information about the requestor of the DC session creation (e.g., the AF or NF identifier), the AF or NF reason for triggering a DC session creation including an AF or NF level session identifier (e.g., a ML training session or any other type of session associated with the DC session), and/or the data to be collected by UE or gNodeB members and the endpoint information where to send the collected data.

The AF or NF reason for triggering a DC session may indicate that the DC session is for training a ML model, may indicate an identifier of a ML model that is being (re)trained and may include an identifier for the corresponding ML model training session. If the reason for triggering the DC session creation is for ML training, the request may identify the ML Model whose performance may have degraded and a ML model training session identifier that identifies the ML model training action.

Messages sent to the DCF may be sent directly as a service-based messages or may be sent indirectly through the NEF.

The AF or NF may have registered to the DCF, and the DCF may know how to reach the AF or NF based on the registration information. Alternatively, the DCF may discover the AF or NF via the NRF.

In step 5, upon receiving the request, the DCF may perform actions such as determining whether the requestor is authorized to request a DC session creation for the reasons provided in the request and for the data collection requirements and for the provided members. The DCF may assign a DC session identifier if it determines that a DC session can be created.

The DCF may create a DC profile or may determine an existing DC profile based on the information provided in the DC session creation request. The DC profile may include information about the DC requirements (e.g., data to be collected, frequency, duration, etc.), and communication requirements for data collection. Different data collection members may require different DC profiles, and the DCF may determine different DC profiles for the members of the DC session.

Based on the determined DC profile(s), the DCF may initiate a DC session establishment for each of the members associated with the DC session;. The DCF may perform the DC session establishment procedure described in FIG. 5 one or more times (e.g., for each data collection member) if the DC session includes one or more members for collecting the data. The DC session establishment performed with each member is further described in FIG. 5.

In step 6, the DCF may send a DC session creation response to the AF or NF, indicating whether the DC session can be created. The response may include a DC session identifier if the DC session is created, otherwise the response may indicate a failure and may include a reason for failure.

The AF or NF may store the DC session identifier and/or associate the provided DC session identifier for the purpose of managing the DC session, for example, for terminating a DC session. Additionally, the AF or NF may use the DC session identifier for the purpose of identifying the collected data that is received at the AF or NF from the one or more DC session members, as described in FIG. 5. The collected data sent to the AF or NF may be identified with the DC session identifier which allows the AF or NF to determine for which purpose the DC data is received as shown in step 7 of FIG. 5.

FIG. 5 is an example depiction of a data collection session establishment procedure. FIG. 5 describes alternative examples of data collection session establishment. FIG. 5 is a detailed view of Stage 3 of FIG. 2. FIG. 5 shows that the DCF may trigger establishment of a data collection session. This procedure may alternatively be performed by a NF other than the DCF. For example, the UDM/UDR may trigger the establishment of a data collection session.

In step 1, a first alternative for DC session establishment is described. In the first alternative, the DCF may trigger DC session establishment as described in FIG. 4, and the triggering may occur via a NAS message. The DCF may send a DC session request (1a) to the AMF. The request may include one or more DC profile identifier, one or more DC profile, a DC session identifier. The request may be a service-based message. Additionally, an endpoint for the data collection session may be provided and may, for example, correspond to the endpoint of ML training nodes as described in FIG. 4. In this first alternative and upon receiving the request, the AMF may send an NAS message (1b) to each selected member. The NAS message may include, for each selected member, a DC session identifier and DC profile identifier and/or a DC profile indicating the DC requirements for the DC session.

In step 2, a second alternative for DC session establishment is described. In the second alternative, the DCF may trigger DC session establishment as described in FIG. 4, and the triggering may occur via the gNodeB. The DCF may send a DC session request (2a) to the AMF as described in step 1a of FIG. 5.

In this second alternative and upon receiving the request, the AMF may send, for each of the selected member, a message (2b) to the AN to indicate the SC session creation request. The request may include for each selected member a DC session identifier, a DC profile identifier and/or a DC profile indicating the DC requirements for the DC session. Additionally, an endpoint for the data collection session may be provided and may, for example, correspond to the endpoint of ML training nodes as described in FIG. 4.

The AN may send a message (2c) to the gNodeB to indicate the DC session creation request. The request may include a DC session identifier, a DC profile identifier and/or a DC profile indicating the DC requirements for the DC session. Although not shown in FIG. 5, a DC session for data collection may be for DC at the gNodeB. The gNodeB may configure a DC session based on the received DC session identifier and DC profile information received in step 2c of FIG. 5.

The gNodeB may use the provided DC profile identifier to identify a DC profile that may be available at the gNodeB or alternatively may use the provided DC profile.

Configuring a DC session may include configuring connectivity for reporting the collected data and configuring the collection of measurements to be reported.

A first configuration performed by the gNodeB may be for configuring connectivity for reporting the collected data. The endpoint for data collection may be used by the gNodeB to report the collected data. The endpoint may be provided in the DC profile (e.g., determined or obtained) or may otherwise have been provided as part of the DC session information received.

A second configuration performed by the gNodeB may be for configuring the collection of measurements to be reported. Configuring measurements to be reported may include creating data collection task(s) for collecting measurements, and/or configuring the measurement collection patterns according to a DC profile (e.g., frequency, size, etc.), or the like.

A final configuration performed by the gNodeB may be for configuring the data collection task(s) (e.g., second configuration) for reporting the collected data using the data collection connectivity (e.g., first configuration). The configuration may include using the DC session identifier to identify the collected data before it is sent to the reporting endpoint.

The gNodeB may send a message (2d) to the WTRU MT to indicate the DC session creation request. The request may include a DC session identifier, a DC profile identifier and/or a DC profile indicating the DC requirements for the DC session. A DC session information indication from the gNodeB to the MT may be communicated via the RRC layer, via Downlink Control Information (DCI) or via Medium Access Control Elements (MAC-CEs).

In step 3, a third alternative for DC session establishment is described. In the third alternative, the DCF may trigger DC session establishment as described in FIG. 4, and the triggering may occur via service-based message send to the UE MT. The DCF may send, for each of the selected member, a service-based message (3a) to the MT. The message may include a DC session identifier, and a DC profile identifier and/or a DC profile indicating the DC requirements for the DC session. Additionally, an endpoint for the data collection session may be provided and may, for example, correspond to the endpoint of ML training nodes as described in FIG. 4.

In step 4, a fourth alternative for DC session establishment is described. In the fourth alternative, the DCF may trigger DC session establishment as described in FIG. 4, and the triggering may occur via service-based message send to the gNodeB. The DCF may send, for each of the selected members, a service-based message (4a) to the gNodeB. The message may include a DC session identifier, and a DC profile identifier and/or a DC profile indicating the DC requirements for the DC session. Additionally, an endpoint for the data collection session may be provided and may, for example, correspond to the endpoint of ML training nodes as described in FIG. 4.

The gNodeB may send a message (4b) to the WTRU MT to indicate the SC session creation request as described in step 2d of FIG. 5.

Although not shown in FIG. 5, a DC session for data collection may be for DC at the gNodeB. The gNodeB may configure a DC session based on the received DC session identifier and DC profile information received in step 4a of FIG. 5. The actions performed by a gNodeB for collecting data are described in step 2c of FIG. 5.

In step 5, the MT may configure a DC session based on the received DC session identifier and DC profile information received in step 1, step 2, step 3, or step 4 of FIG. 5. The MT may use the provided DC profile identifier to identify a DC profile that may be available at the MT or alternatively may use the provided DC profile.

Configuring a DC session may include configuring connectivity for reporting the collected data and configuring the collection of measurements to be reported. A first configuration performed by the MT is for configuring connectivity for reporting the collected data. Configuring connectivity may include creating a PDU session for the purpose of reporting collected data. The PDU session creation may require that an endpoint for data collection be provided. The endpoint for data collection may be part of the DC profile (e.g., determined or obtained) or may otherwise have been provided as part of the DC session information received.

A second configuration performed by the MT is for configuring the collection of measurements to be reported. Configuring measurements to be reported may include creating data collection task(s) for collecting measurements and/or configuring the measurement collection patterns according to a DC profile (e.g., frequency, size, etc.). The configuration may include sending an event to the transmit entity (TE) (e.g., an application layer event) for triggering the data collection at the application layer.

Another configuration performed by the MT is for configuring the data collection task(s) (e.g., second configuration) for reporting the collected data using the data collection connectivity (e.g., first configuration). The configuration may include using the DC session identifier to identify the collected data before it is sent to the reporting endpoint.

In step 6 and step 7, data may be collected and communicated according to the first and second configurations. The data sent may be associated with the DC session identifier such that the receiving end can associate the received data with an ongoing session.

In step 8, an AF or NF may receive the collected data and, for example, uses the collected data for training a ML model. The DC session identifier may be used by the AF or NF to identify an ongoing DC session and may be used to identify a ML model being trained, or a ML model training session.

FIG. 6 is an example depiction of a data collection session termination procedure. FIG. 6 describes alternative examples of data collection session termination procedures. FIG. 6 is a detailed view of Stage 4 of FIG. 2. The example depiction represented in FIG. 6 shows that the DCF may trigger termination of a data collection session. This procedure alternatively may be performed by an NF other than the DCF. For example, the UDM/UDR may trigger the termination of a data collection session.

In step 1, a first alternative for DC session termination is described. In the first alternative, the WTRU MT may trigger DC session termination, and the triggering may occur via a NAS message. The MT may terminate the DC session (1a). Terminating the DC session means that the MT terminated the data collection task at the WTRU and/or terminates the data collection communication with the network. Upon terminating the DC session, the MT may send a message (1b) to the network to indicate that the DC session has been terminated. The MT may send a DC session termination message (1b) to the AMF in a NAS message. The request may include a DC profile identifier associated with the DC session and a DC session identifier, and additionally may include a reason for terminating the DC session. For example, the MT may indicate that the DC session was terminated because a data collection timer has expired. As another example, the MT may indicate that the DC session was terminated due to power constraints at the WTRU.

Upon receiving the NAS message from the WTRU, the AMF may send (1c) DC session termination information to the DCF. The AMF may have determined the selection of DCF associated with the WTRU at WTRU registration time and may have updated the selection of DCF on WTRU mobility events. Alternatively, the AMF may use the DC session identifier included in the message to identify the DCF that initiated the DC session as described in FIG. 5. The message sent to the DCF may be a service-based message.

Upon receiving the service-based message from the AMF, the DCF may send a DC session termination message (1d) to the AF or NF. Upon receiving the message, the AF or NF may determine if ML model training needs to be terminated based on the list of selected members for training. If most selected members for training have terminated their DC sessions, the AF or NF may choose to terminate ML model training. Otherwise, if few selected members for training have terminated their DC sessions, the AF or NF may choose to continue model training. If the AF or NF determines that the DC session is not required anymore, the AF or NF may send a DC session terminate request to the DCF (not shown on FIG. 6) to indicate that the DC session should be terminated for all members of the DC session.

In step 2, a second alternative for DC session termination is described. In the second alternative, the WTRU MT may trigger DC session termination, and the triggering may occur via gNodeB messaging. The MT may determine to terminate a DC session (2a) as described in step 1a of FIG. 6.

The MT may send an indication (2b) of the DC session termination to the gNodeB. An indication from the MT to the gNodeB may be communicated via the RRC layer, via Uplink Control Information (UCI) or via a Medium Access Control Element (MAC-CE). The communicated information may include the DC profile identifier associated with the DC session and/or a DC session identifier, and additionally may include a reason for terminating the DC session.

The gNodeB may send a message (2c) to the AN to indicate the DC session termination. The message may include the DC profile identifier associated with the DC session and a DC session identifier, and additionally may include a reason for terminating the DC session.

The AN may send a message (2d) to the AMF to indicate the DC session termination. The message may include the DC profile identifier associated with the DC session and/or a DC session identifier, and additionally may include a reason for terminating the DC session.

The AMF may send a message (2e) to the DCF to indicate the DC session termination as described in step 1c of FIG. 6.

The DCF may send a message (2f) to the AF or NF to indicate the DC session termination as described in step 1d of FIG. 6.

In step 3, a third alternative for DC session termination is described. In the third alternative, the AF or NF may trigger DC session termination, and the triggering happens via NAS messaging. The AF or NF may determine to trigger the DC session termination. The determination to trigger a DC session termination may be based on a ML model training that is complete and meets performance requirements. The determination to trigger a DC session termination may be based on a ML model training that is not converging.

The AF or NF may send a DC termination message (3a) to the DCF. The message may include a ML model identifier and an indication that the model training should be terminated. Additionally, the message may include the DC profile identifier associated with the DC session and/or a DC session identifier, may include one or more selected members for ML model training, and may include a reason for terminating the DC session.

The DCF may use the ML model identifier provided in the message to retrieve a ML profile from the UDM/UDR, determine one or more DC profiles associated with a ML profile, and trigger the DC session termination of DC profile associated with each selected members for ML model training that are associated with the trained ML model, or trigger the DC session termination for all selected members associated with the trained model.

The DCF may use the DC session identifier provided in the message to trigger the DC session termination of DC profile associated with each selected member associated with the DC session identifier; or trigger the DC session termination for all selected members associated with the DC session identifier.

The DCF may use selected members for ML model training provided in the message to retrieve the DC profile associated with each member and trigger the DC session termination of each member.

The DCF may send a message (3b) to the AMF to indicate the DC session termination. The message may include the DC profile identifier associated with the DC session and/or a DC session identifier, and additionally may include a reason for terminating the DC session.

The AMF may send a NAS message (3c) to the MT to indicate the DC session termination. The message may include the DC profile identifier associated with the DC session and/or a DC session identifier, and additionally may include a reason for terminating the DC session. The MT upon receiving the NAS message may terminate the DC session as described in step 1a of FIG. 6.

Various DC policies may be applicable to a DC session.

Regarding DC authorization policy users, a DC authorization policy may be available and provided by the network to allow the establishment of a DC session. The DC authorization policy may be provided to a WTRU. The MT in step 5 of FIG. 5 may use a DC authorization policy to determine if a DC session can be configured and established at the WTRU.

The DC authorization policy may be provided to a gNodeB. The gNodeB in step 2c of FIG. 5 or step 4a of FIG. 5 may use a DC authorization policy to determine if a DC session can be configured and established at the gNodeB.

The DC authorization policy may be provided to a DCF. The DCF in step 5 of FIG. 4 may use a DC authorization policy to determine if a DC session can be configured with selected members for a DC session.

A WTRU may be authorized by sending a NAS message or via PDU session establishment or by sending a service-based message to the DCF, by indicating a DC type and/or associated data network name/single network slice selection assistance information (DNN/S-NSSAI) according to the DC authorization policy. The network may accept or reject the WTRU initiated message and the WTRU may backoff and retry to obtain a DC authorization later according to a rejection message and/or cause.

A WTRU may release a PDU session used for a DC session when the conditions for a DC authorization policy become invalid or when instructed to stop by the network, via a DC session termination or a policy update.

Regarding DC authorization policy management, a DC authorization policy may be stored and maintained in a network function such as the PCF. A DC authorization policy may be updated by authorized entities any time and such updates may be based on network events; for example, the policy may be updated on mobility registration or when a request to manage (e.g., establish or terminate) a DC session is received.

Regarding DC authorization policy rules, a DC authorization policy may indicate rules and conditions to determine if data collection may be performed at certain functional entities, for example to determine if data collection is authorized for WTRU(s) and gNodeB(s).

The policy may include requestor-based rules and conditions to determine if a DC session can be managed (e.g., established, requested or terminated). The requestor-based rule may indicate which functional entity may manage a DC session; for example, the requestor-based rule may indicate that a WTRU, a gNodeB, an AF, a NF or any combination thereof are allowed to manage a DC session.

The policy may include time-based rules and conditions to determine when a DC session can be managed (e.g., established, requested or terminated). A time-based rule may indicate when a DC session is allowed; a DC session may be allowed at a specific period or time of day.

The policy may include location-based rules and conditions to determine if a DC session can be managed (e.g., established, requested or terminated). A location-based rule may indicate a location where a DC session is allowed; a DC session may be allowed at a specific geolocation, a certain tracking area, and/or a certain cell identifier.

The policy may include traffic-based rules and conditions to determine if a DC session can be managed (e.g., established, requested or terminated). A traffic-based rule may indicate a traffic budget that is allowed for the DC session transport. A DC session may be allowed for or capped at a maximum bitrate.

The policy may include type-based rules and conditions to determine if a DC session can be managed (e.g., established, requested or terminated). A type-based rule may indicate the type of operation allowed for requesting a DC session. A DC session may be allowed for ML model training or for providing sensing data.

The policy may include communication-based rules and conditions associated with a DC session. Communication-based rules may indicate that a DC session is allowed to use a slice (e.g., slice identifier) or allowed to communicate with a specific data network (DN) or edge data network (EDN) (e.g., a DNN). Additionally, the rule may indicate authorized access network that can be used to transport the DC session data.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media (which do not include transitory signals). Examples of computer-readable storage media, which are differentiated from signals, may include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Any of the operations, processes, etc. described herein may be implemented as computer-readable instructions stored on a computer-readable storage medium. The computer-readable instructions may be executed by a processor of a mobile unit, a network element, and/or any other computing device.

What is claimed is:

1. A wireless transmit/receive unit (WTRU) comprising:
a transceiver; and
a processor configured to:
detect a data collection (DC) condition, wherein the DC condition is based upon performance of an artificial intelligence/machine learning (AIML) model;
based on the detected DC condition, send, via the transceiver, a first message, wherein the first message comprises at least one of an indication that the DC condition has been detected or a request to establish a DC session;
receive, via the transceiver, a second message, wherein the second message comprises an indication that a DC session has been established and an indication of a DC session identifier associated with the session;
receive, via the transceiver, configuration information, wherein the configuration information comprises an indication for the WTRU to collect and report data based on a DC profile, a DC endpoint, and a DC authorization policy;
collect data based on the DC profile and the DC authorization policy;
send, via the transceiver, an indication of the DC session identifier and at least a portion of the collected data to the DC endpoint; and
receive, via the transceiver, a third message, the third message comprising an indication of a DC session termination.

2. The WTRU of claim 1, wherein the DC session identifier is associated with a plurality of members for collecting and reporting the data.

3. The WTRU of claim 1, wherein the DC profile comprises an indication of data to be collected.

4. The WTRU of claim 1, wherein the DC profile comprises an indication of data reporting connectivity.

5. The WTRU of claim 1, wherein the DC profile comprises an indication of members associated with the DC session identifier.

6. The WTRU of claim 1, wherein the DC authorization policy comprises an indication of members associated with the DC session that are authorized to collect data.

7. The WTRU of claim 1, wherein the DC condition is based upon performance degradation of the AIML model.

8. The WTRU of claim 1, wherein the processor is further configured to send an indication of performance degradation of the AIML model.

9. The WTRU of claim 1, wherein the DC authorization policy comprises an indication that the WTRU is authorized to collect data.

10. The WTRU of claim 1, wherein the DC authorization policy comprises an indication of members associated with the DC session that are authorized to collect data.

11. A method performed by a wireless transmit/receive unit (WTRU), the method comprising:
detecting a data collection (DC) condition, wherein the DC condition is based upon performance of an artificial intelligence/machine learning (AIML) model;
based on the detected DC condition, sending a first message, wherein the first message comprises at least one of an indication that the DC condition has been detected or a request to establish a DC session;
receiving a second message, wherein the second message comprises an indication that a DC session has been established and an indication of a DC session identifier associated with the session;
receiving configuration information, wherein the configuration information comprises an indication for the WTRU to collect and report data based on a DC profile, a DC endpoint, and a DC authorization policy;
collecting data based on the DC profile and the DC authorization policy;
sending an indication of the DC session identifier and at least a portion of the collected data to the DC endpoint; and
receiving a third message, the third message comprising an indication of a DC session termination.

12. The method of claim 11, wherein the DC session identifier is associated with a plurality of members for collecting and reporting the data.

13. The method of claim 11, wherein the DC profile comprises an indication of data to be collected.

14. The method of claim 11, wherein the DC profile comprises an indication of data reporting connectivity.

15. The method of claim 11, wherein the DC profile comprises an indication of members associated with the DC session identifier.

6. The method of claim 11, wherein the DC authorization policy comprises an indication of members associated with the DC session that are authorized to collect data.

17. The method of claim 11, wherein the DC condition is based upon performance degradation of the AIML model.

18. The method of claim 11, further comprising sending an indication of performance degradation of the AIML model.

19. The method of claim 11, wherein the DC authorization policy comprises an indication that the WTRU is authorized to collect data.

20. The method of claim 11, wherein the DC authorization policy comprises an indication of members associated with the DC session that are authorized to collect data.
